(19) United States
(12) Patent Application Publication
(10) Pub. No.: US 2010/0287055 A1
(43) Pub. Date: Nov. 11, 2010

(54) Advertisement system and method

(76) Inventors: Geraldine Robinson, St. Louis, MO (US); Donald Lawrence Clark, Vacaville, CA (US); George Washington Graham, Memphis, TN (US)

Correspondence Address: HOLLAND & KNIGHT LLP, 10 ST. JAMES AVENUE, BOSTON, MA, 02116-3889, US

(21) Appl. No.: 12/311,047

(22) PCT Filed: Sep. 21, 2007
(86) PCT No.: PCT/US2007/079167

§ 371 Date: May 13, 2010

(30) Foreign Application Priority Data
Sep. 21, 2006 (US) 11/533832
Jun. 11, 2007 (US) 11760878

(51) Int. Cl. G06Q 30/00

(52) U.S. Cl. 705/14.73

(57) ABSTRACT

A method, computer program product, and computing device for storing a first advertisement in a non-volatile storage device within a computing device. The first advertisement is rendered on the computing device during a first firmware boot sequence of the computing device. A second advertisement is stored in the non-volatile storage device within the computing device.

### RELATED APPLICATION(S)

This application claims priority to U.S. patent application Ser. No. 11/760,878, filed 11 Jun. 2007, which is a continuation-in-part of and claims priority to U.S. patent application Ser. No. 11/533,832, filed 21 Sep. 2006, which are herein incorporated by reference.

### TECHNICAL FIELD

This disclosure relates to advertisements and, more particularly, to advertisements that are rendered during a firmware boot Sequence.

### BACKGROUND

Computer-based advertising is a multi-billion dollar industry that has been exploited in numerous ways. For example, websites are replete with banner advertisements. Additionally, popup/popover ads may be rendered while a user is browsing a website. Further, video advertisements may be rendered as a prerequisite to viewing e.g., a news video clip. Unfortunately, all of these advertisements are easily bypassable/ignorable by the user. For example, banner advertisements and video advertisements may be ignored, and popup/popover advertisements may be closed.

### SUMMARY OF DISCLOSURE

In a first implementation, a method includes storing a first advertisement in a non-volatile storage device within a computing device. The first advertisement is rendered on the computing device during a first firmware boot sequence of the computing device. A second advertisement is stored in the non-volatile storage device within the computing device.

One or more of the following features may be included. The second advertisement may be rendered on the computing device during a second firmware boot sequence of the computing device. The first advertisement may be deleted from the non-volatile storage device.

The computing device may be chosen from the group consisting of: a personal computer, a laptop computer, a notebook computer, a personal digital assistant, a cellular telephone, a portable game console and a personal media device. At least one of the first and second advertisements may be chosen from the group consisting of: an audio-based advertisement; a text-based advertisement, a graphic-based advertisement and a video-based advertisement. At least one of the first and second advertisements may be obtained from a remote advertisement server coupled to the computing device via a distributed computing network.

The non-volatile storage device may be chosen from the group consisting of: a non-volatile storage device included within a video card; a non-volatile storage device included within a daughter card; a non-volatile storage device included within an audio card; a non-volatile storage device included within a network interface card; a non-volatile storage device included within a hard drive controller card; a non-volatile storage device included within a peripheral device controller card; and a non-volatile storage device included within a system board of the computing device. The non-volatile storage device may be chosen from the group consisting of: a Programmable Read-Only Memory (PROM); an Erasable Programmable Read-Only Memory (EPROM); an Electrically Erasable Programmable Read-Only Memory (EEPROM); and a flash memory device. The firmware boot sequence may include a BIOS boot sequence.

In another implementation, a computer program product resides on a computer readable medium and has a plurality of instructions stored on it. When executed by a processor, the instructions cause the processor to perform operations including storing a first advertisement in a non-volatile storage device within a computing device. The first advertisement is rendered on the computing device during a first firmware boot sequence of the computing device. A second advertisement is stored in the non-volatile storage device within the computing device.

One or more of the following features may be included. The second advertisement may be rendered on the computing device during a second firmware boot sequence of the computing device. The first advertisement may be deleted from the non-volatile storage device.

The computing device may be chosen from the group consisting of: a personal computer, a laptop computer, a notebook computer, a personal digital assistant, a cellular telephone, a portable game console and a personal media device. At least one of the first and second advertisements may be chosen from the group consisting of: an audio-based advertisement; a text-based advertisement, a graphic-based advertisement and a video-based advertisement. At least one of the first and second advertisements may be obtained from a remote advertisement server coupled to the computing device via a distributed computing network.

The non-volatile storage device may be chosen from the group consisting of: a non-volatile storage device included within a video card; a non-volatile storage device included within a daughter card; a non-volatile storage device included within an audio card; a non-volatile storage device included within a network interface card; a non-volatile storage device included within a hard drive controller card; a non-volatile storage device included within a peripheral device controller card; and a non-volatile storage device included within a system board of the computing device. The non-volatile storage device may be chosen from the group consisting of: a Programmable Read-Only Memory (PROM); an Erasable Programmable Read-Only Memory (EPROM); an Electrically Erasable Programmable Read-Only Memory (EEPROM); and a flash memory device. The firmware boot sequence may include a BIOS boot sequence.

In another implementation, a computing device includes circuitry configured for performing operations including storing a first advertisement in a non-volatile storage device within a computing device. The first advertisement is rendered on the computing device during a first firmware boot sequence of the computing device. A second advertisement is stored in the non-volatile storage device within the computing device.

One or more of the following features may be included. The second advertisement may be rendered on the computing device during a second firmware boot sequence of the computing device. The first advertisement may be deleted from the non-volatile storage device.

The computing device may be chosen from the group consisting of: a personal computer, a laptop computer, a notebook computer, a personal digital assistant, a cellular telephone, a portable game console and a personal media device. At least one of the first and second advertisements may be chosen from the group consisting of: an audio-based advertisement; a text-based advertisement, a graphic-based advertisement and a video-based advertisement. At least one of the first and second advertisements may be obtained from a remote advertisement server coupled to the computing device via a distributed computing network.

The non-volatile storage device may be chosen from the group consisting of: a non-volatile storage device included within a video card; a non-volatile storage device included within a daughter card; a non-volatile storage device included within an audio card; a non-volatile storage device included within a network interface card; a non-volatile storage device included within a hard drive controller card; a non-volatile storage device included within a peripheral device controller card; and a non-volatile storage device included within a system board of the computing device. The non-volatile storage device may be chosen from the group consisting of: a Programmable Read-Only Memory (PROM); an Erasable Programmable Read-Only Memory (EPROM); an Electrically Erasable Programmable Read-Only Memory (EEPROM); and a flash memory device. The firmware boot sequence may include a BIOS boot sequence.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of an advertisement process and a computing device coupled to a distributed computing network;

FIG. 2 is a flowchart of the advertisement process of FIG. 1;

FIG. 3 is a diagrammatic view of the computing device of FIG. 1; and

FIG. 4 is a diagrammatic view of the computing device of FIG. 1.

Like reference symbols in the various drawings indicate like elements.

### DETAILED DESCRIPTION OF THE PREFERRED EMBODIMENTS

### System Overview

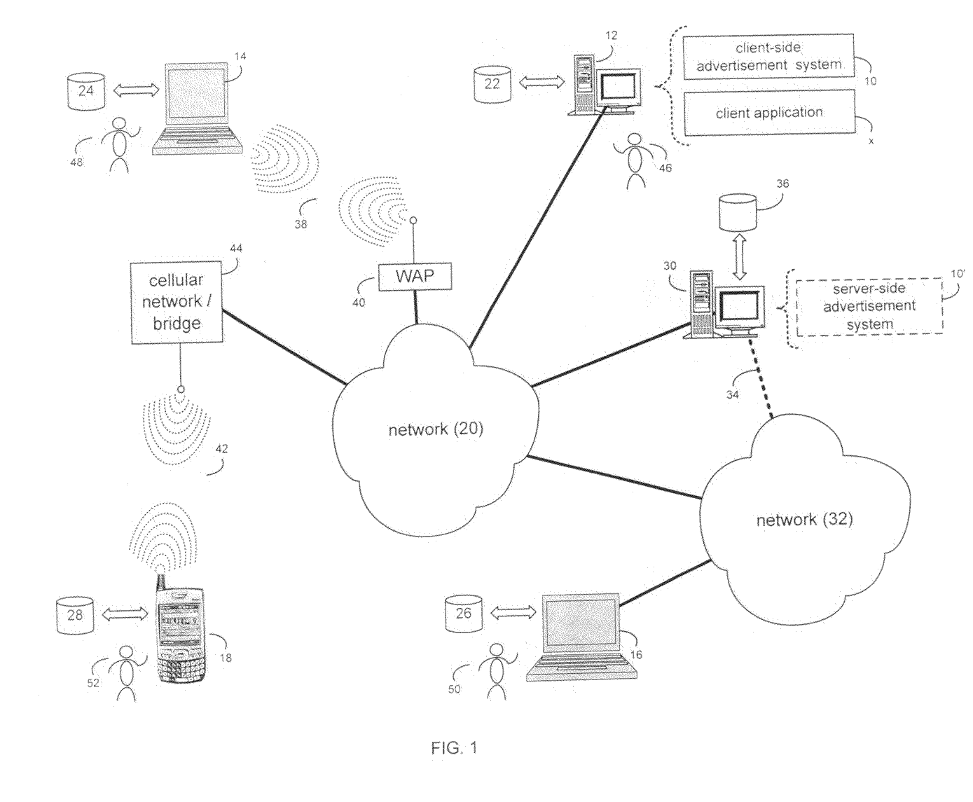

Referring to FIG. 1, there is shown an advertisement process 10 that may reside on and may be executed by a computing device. Examples of computing devices may include, but are not limited to, personal computer 12, laptop computer 14, notebook computer 16, personal digital assistant 18, a cellular telephone (not shown), a portable game console (not shown) and a personal media device (not shown). As will be discussed below in greater detail, advertisement process 10 may store advertisements within the computing device for rendering during a firmware boot sequence of the computing device.

Advertisement process 10 may be a client-side application that resides on and is executed by a computing device (e.g., personal computer 12, laptop computer 14, notebook computer 16, personal digital assistant 18), each of which may be coupled to network 20 (e.g., the Internet). The instruction sets and subroutines of advertisement process 10, which may be stored on storage device 22, 24, 26, 28 (respectively) coupled to e.g., personal computer 12, laptop computer 14, notebook computer 16, personal digital assistant 18 (respectively), may be executed by one or more processors (not shown) and one or more memory architectures (not shown) incorporated into personal computer 12, laptop computer 14, notebook computer 16, and personal digital assistant 18. Examples of storage device 22, 24, 26, 28 may include but are not limited to: a hard disk drive; a tape drive; an optical drive; a RAID array; a random access memory (RAM); a read-only memory (ROM); a compact flash (CF) storage device, a secure digital (SD) storage device, and a memory stick storage device.

Additionally, the above-described advertisement process may include a server-based application, as represented in FIG. 1 by server-side advertisement process 10′ (shown in phantom). Server-side advertisement process 10′ may reside on and may be executed by data server 30, which may also be coupled to network 20. Examples of data server 30 may include, but are not limited to: a personal computer, a server computer, a series of server computers, a mini computer, and a mainframe computer, for example. Data server 30 may execute a network operating system, examples of which may include but are not limited to: Microsoft Windows XP Server™; Novell Netware™; or Redhat Linux™, for example. Data server 30 may execute a web server application, examples of which may include but are not limited to: Microsoft IIS™, Novell Webserver™, or Apache Webserver™, that allows for HTTP (i.e., HyperText Transfer Protocol) access to data server 30 via network 20.

Network 20 may be coupled to one or more secondary networks (e.g., network 32), examples of which may include but are not limited to: a local area network; a wide area network; or an intranet, for example. Data server 30 (i.e., the computer that executes server-side advertisement process 10′) may be coupled to network 20 through secondary network 32, as illustrated with phantom link line 34.

The instruction sets and subroutines of server-side advertisement process 10′, which may be stored on a storage device 36 coupled to data server 30, may be executed by one or more processors (not shown) and one or more memory architectures (not shown) incorporated into data server 30. Storage device 36 may include but is not limited to: a hard disk drive; a tape drive; an optical drive; a RAID array; a random access memory (RAM); a read-only memory (ROM); a compact flash (CF) storage device, a secure digital (SD) storage device, and a memory stick storage device.

As discussed above, the advertisement process may be a client-side application (e.g., client-side advertisement process 10), a server-side application (e.g., server-side advertisement process 10′), or a hybrid client-side/server-side application (e.g., using portions of both client-side advertisement process 10 and server-side advertisement process 10′). Accordingly, the manner in which the advertisement process is accessed may vary depending on whether the advertisement process is a client-side application, a server-side application, or a hybrid client-side/server-side application.

Client-side advertisement process 10 may interface with server-side advertisement process 10′ and facilitate the bidirectional transfer of data between e.g., data server 30 and the computing devices (e.g., personal computer 12, laptop computer 14, notebook computer 16, personal digital assistant 18, a cellular telephone (not shown), a portable game console (not shown) and a personal media device (not shown)).

The computing devices (e.g., personal computer 12, laptop computer 14, notebook computer 16, personal digital assistant 18, a cellular telephone (not shown), a portable game console (not shown) and a personal media device (not shown)) may each execute an operating system, examples of which may include but are not limited to Microsoft Windows™, Microsoft Windows Mobile™, Redhat Linux™, or a custom operating system.

The computing devices (e.g., personal computer 12, laptop computer 14, notebook computer 16, personal digital assistant 18, a cellular telephone (not shown), a portable game console (not shown) and a personal media device (not shown)) may be directly or indirectly coupled to network 20 (or network 32). For example, personal computer 12 is shown directly coupled to network 20 via a hardwired network connection, and notebook computer 16 is shown directly coupled to network 32 via a hardwired network connection.

Laptop computer 14 is shown wirelessly coupled to network 20 via wireless communication channel 38 established between laptop computer 14 and wireless access point (i.e., WAP) 40, which is shown directly coupled to network 20. WAP 40 may be, for example, an IEEE 802.11a, 802.11b, 802.11g, Wi-Fi, and/or Bluetooth device that is capable of establishing wireless communication channel 38 between laptop computer 14 and WAP 40.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Personal digital assistant 18 is shown wirelessly coupled to network 20 via wireless communication channel 42 established between personal digital assistant 18 and cellular network/bridge 44, which is shown directly coupled to network 20.

Users 46, 48, 50, 52 may use the computing devices (e.g., personal computer 12, laptop computer 14, notebook computer 16, personal digital assistant 18, a cellular telephone (not shown), a portable game console (not shown) and a personal media device (not shown)) to perform various tasks, examples of which may include but are not limited to word processing, graphic arts, making telephone calls, browsing the internet, and playing video games.

### The Advertisement Process:

As discussed above, advertisement process 10 may store advertisements within computing devices for rendering during a firmware boot sequence of the computing device.

When a computing device (e.g., personal computer 12, laptop computer 14, notebook computer 16, personal digital assistant 18, a cellular telephone (not shown), a portable game console (not shown) and a personal media device (not shown)) is first turned on, the computing device executes a boot sequence.

BIOS (i.e., Basic Input/Output System) refers to the firmware code run by a computing device during the boot sequence, in which the BIOS is embedded code stored within non-volatile memory that recognizes and controls various portions of the computing device. The primary function of the BIOS is to prepare the computing device so that other software programs (e.g., operating systems and application programs) may be subsequently loaded, executed, and assume control of the computing device. This process may be collectively referred to as a boot sequence. The portion of the boot sequence in which firmware (e.g., BIOS) code is executed may be referred to as a firmware boot sequence. Further, the portion of the boot sequence in which software code (e.g., an operating system) is executed may be referred to as the software boot sequence.

An example of a firmware boot sequence is the initial boot sequence of a computer in which various devices are initialized to enable the subsequent loading of a software-based operating system. For example, during a firmware boot sequence, one or more drivers may be loaded that initialize a video card, an audio card, a hard disk controller card, a network interface card, a peripheral device controller card, and/or one or more daughter cards. Once the firmware boot sequence is completed, the software boot sequence may be executed, in which e.g., the software-based operating system is loaded.

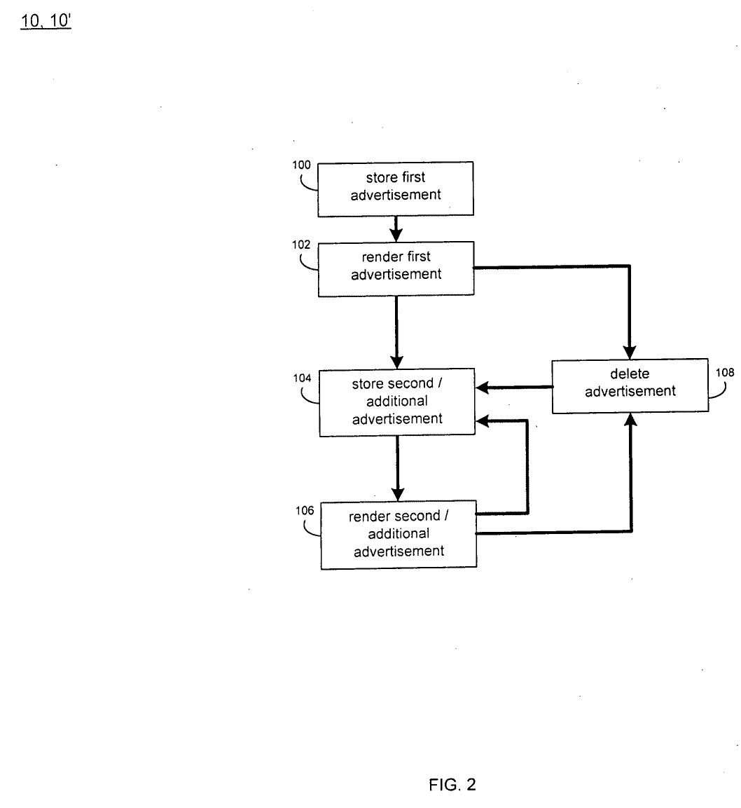

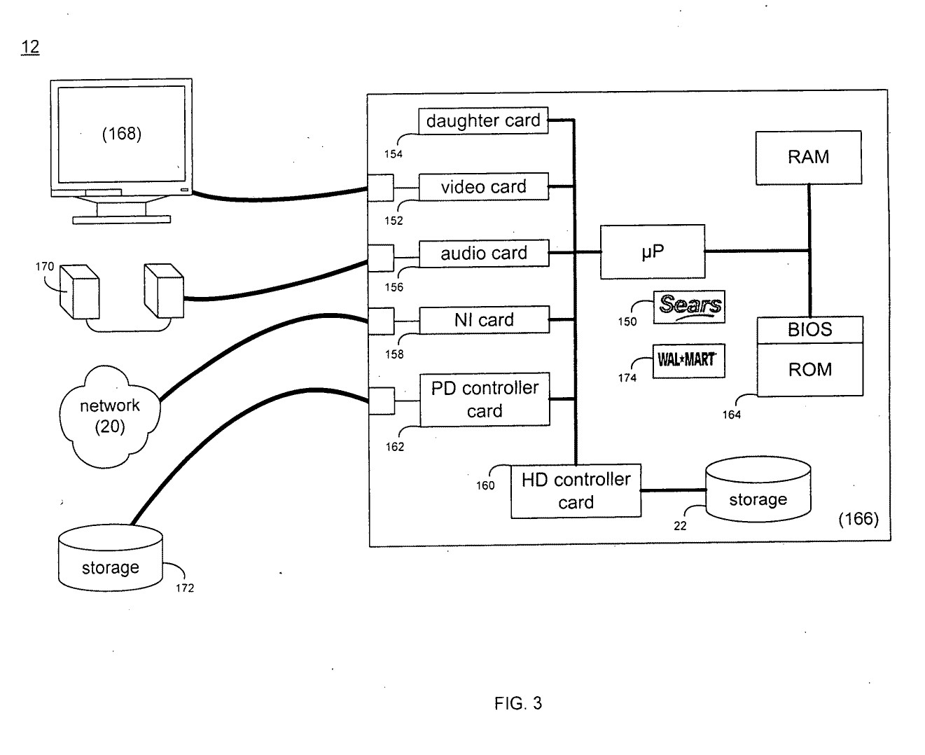

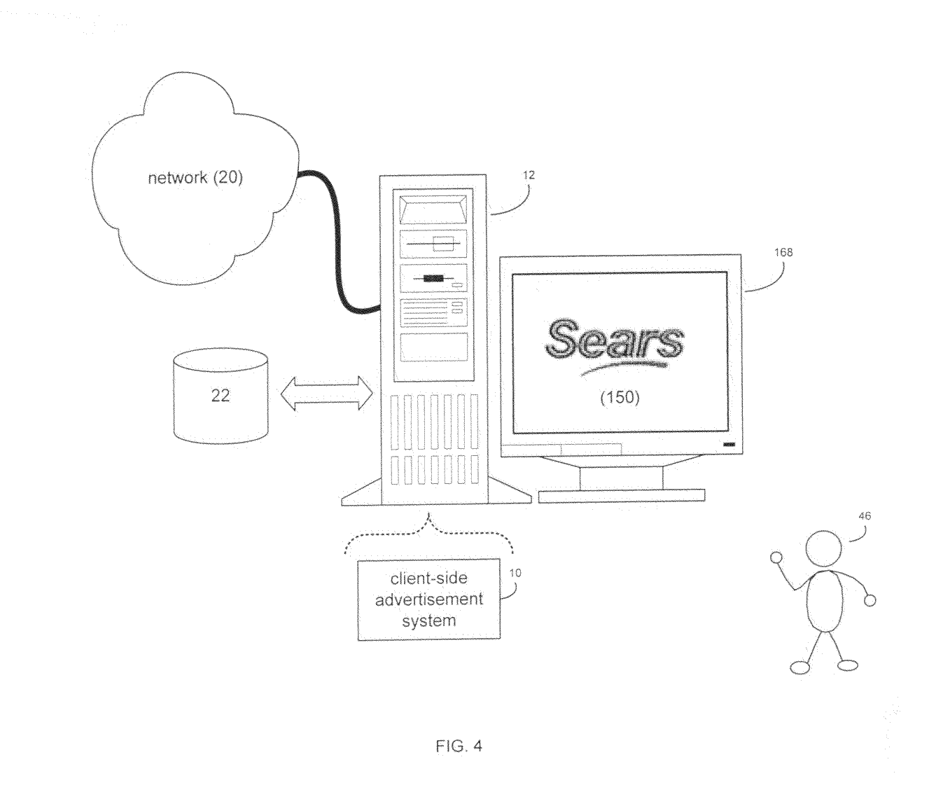

Referring also to FIGS. 2-4, advertisement process 10 may store 100 a first advertisement 150 in a non-volatile storage device within e.g., personal computer 12. Examples of first advertisement 150 may include but are not limited to an audio-based advertisement; a text-based advertisement, a graphic-based advertisement and a video-based advertisement

The non-volatile storage device may be: a non-volatile storage device (not shown) included within video card 152; a non-volatile storage device (not shown) included within daughter card 154; a non-volatile storage device (not shown) included within audio card 156; a non-volatile storage device (not shown) included within network interface card 158; a non-volatile storage device (not shown) included within hard drive controller card 160; a non-volatile storage device (not shown) included within peripheral device controller card 162; and non-volatile storage device 164 included within system board 166 of personal computer 12. Examples of the non-volatile storage device included within cards 152, 154, 156, 158, 160, 162 and/or board 166 may include but are not limited to a Programmable Read-Only Memory (PROM); an Erasable Programmable Read-Only Memory (EPROM); an Electrically Erasable Programmable Read-Only Memory (EEPROM); and a flash memory device.

Video card 152 may be coupled to display device 168 (e.g., a CRT monitor, a flat panel display screen, or an embedded LCD display). Daughter card 154 may be a memory card (which includes a non-volatile storage device; not shown) that is capable of storing advertisements. Audio card 156 may be coupled to audio system 170 (e.g., one or more speakers, or a pair of headphones). Network interface card 158 may be coupled to e.g., network 20. Hard drive controller card 160 may be coupled to storage device 22. Peripheral device card 162 may be coupled to one or more internal and/or external devices 172. An example of a peripheral device card 162 may include but is not limited to a SCSI (i.e., Small Computer System Interface) controller card.

During operation of personal computer 12, personal computer 12 may access a remote computing device to obtain advertisements. For example, personal computer 12 may access data server 30. As discussed above, data server 30 may execute server-side advertisement process 10′. Accordingly, client side advertisement process 10 may interface with (via e.g., network 20 and/or network 32) server-side advertisement process 10′ to obtain advertisements. Server-side advertisement process 10′ may function as an advertisement repository and may provide advertisements to client-side advertisement process 10. When obtaining advertisements from server-side advertisement process 10′, client-side advertisement process 10 may obtain one or a plurality of advertisements. Specifically, the number of advertisements received may be adjusted in accordance with e.g., design criteria and/or the storage capacity of the non-volatile storage device. The process of interfacing with server-side advertisement process 10′ and obtaining advertisements may be transparent to the user and may occur in the background. Once received, advertisement process 10 may store 100 the advertisement(s) within the non-volatile storage device. As described above, this non-volatile storage device may be included within video card 152, daughter card 154, audio card 156, network interface card 158, hard drive controller card 160, peripheral device controller card 162, and system board 166 of personal computer 12.

Upon the computing device 10 being powered off and subsequently powered on, the above-described firmware boot sequence may be initiated. At some point during this boot sequence, advertisement process 10 may render 102 an advertisement on the computing device (e.g., on display device 168 coupled to personal computer 12). The manner in which the advertisement is rendered may vary depending on the type of advertisement.

The exact point within the firmware boot sequence may be determined based upon design criteria. For example and as discussed above, examples of the advertisement may include but are not limited to an audio-based advertisement; a text-based advertisement, a graphic-based advertisement and a video-based advertisement. Accordingly, audio-based advertisements may be rendered using e.g., audio card 156 and audio system 170. A graphic-based and text-based advertisement may be rendered using e.g., video card 152 and display device 168. A video-based advertisement may be rendered using e.g., audio card 156, audio system 170, video card 152, and display device 168.

Accordingly, a prerequisite for rendering an audio-based advertisements may be the initialization of audio card 158. And a prerequisite for rendering a graphic-based and/or text-based advertisement may be the initialization of video card 152. Further, a prerequisite for rendering a video-based advertisement may be the initialization of video card 152 and audio card 156.

Further, the non-volatile storage device upon which the advertisement to be rendered is stored may need to be initialized prior to rendering an advertisement. Therefore, if a video-based advertisement is stored on e.g., daughter card 154, a prerequisite for rendering the subject video-based advertisement may be the initialization of video card 152, daughter card 154 and audio card 156.

Continuing with the above-stated example, once the appropriate devices are initialized, advertisement 150 may be rendered by advertisement process 10 during the above-described firmware boot sequence. For illustrative purposes, assume that advertisement 150 is an graphic-base advertisement for Sears™ that was previously-stored 100 on daughter card 154. Accordingly, once e.g., video card 152 and daughter card 154 are initialized during the above-described firmware boot sequence, advertisement process 10 may render 102 advertisement 150 on display device 168. The amount of time that advertisement 150 is rendered 102 by advertisement process 10 may vary depending on design criteria. For example, the advertisement may be rendered for a short duration of time (e.g., one second), which may represent only a portion of the duration of the firmware boot sequence. Alternatively, advertisement 150 may be rendered during the entire firmware boot sequence (e.g., from the time that the required devices are initialized until the time that the software-based operating system begins to load). Alternatively, the advertisement may be rendered for an extended period of time by instituting a delay period into the firmware boot sequence. For example, once the required devices are initialized, the advertisement may be rendered and the firmware boot sequence may be “paused” for a defined period of time to allow for extended viewing of the advertisement. Such a delay period may be required for e.g., video-based advertisements in which the time required to render the video-based advertisement is greater than the time required for the firmware boot sequence to fully execute.

As discussed above, once the firmware boot sequence is completed, the software-based operating system may be loaded. Personal computer 12 may again access e.g., data server 30 (which may execute server-side advertisement process 10′) to obtain additional advertisements. As discussed above, when obtaining advertisements from server-side advertisement process 10′, client-side advertisement process 10 may obtain one or a plurality of advertisements. Accordingly, it may not be necessary for advertisement process 10 to obtain a new advertisement each time that one advertisement is rendered. For example, if advertisement process 10 obtains (from server-side advertisement process 10′) advertisements in groups of ten, advertisement process 10 may only need to obtain new advertisements e.g., after the execution of every tenth firmware boot sequence. Additionally, the number of times that an advertisement is rendered may be varied in accordance with design criteria. For example, advertisement 150 may be rendered e.g., five times in a row prior to rendering a different advertisement. Accordingly, if advertisement process 10 obtains a lot of ten advertisements from server-side advertisement process 10′ and each of those advertisements is rendered five time, advertisement process 10 may only need to get additional advertisements after fifty firmware boot sequences.

Regardless of whether advertisement process 10 obtains advertisements one at a time (e.g., obtain first advertisement, render first advertisement, obtain second advertisement, render second advertisement . . . ) or obtains the advertisement in lots (e.g., obtain first and second advertisement, render first advertisement, render second advertisement), advertisement process 10 may obtain additional advertisements from e.g., server-side advertisement process 10′ and may store 104 these additional advertisements in the above-described non-volatile storage device (e.g., daughter card 154) within personal computer 12.

Continuing with the above-stated example and for illustrative purposes, assume that after advertisement process 10 stores 100 and renders 102 first advertisement 150, advertisement process 10 obtains (from server-side advertisement process 10″) and stores 104 advertisement 174 (e.g., an advertisement for Wal-Mart™). Upon the computing device 10 being powered off and subsequently powered on, the above-described firmware boot sequence may be initiated. Once the appropriate devices are initialized during that firmware boot sequence, advertisement 174 may be rendered 106 by advertisement process 10 during the above-described firmware boot sequence.

As discussed above, when obtaining advertisements from server-side advertisement process 10′, client-side advertisement process 10 may obtain one or a plurality of advertisements. Accordingly, when obtaining new advertisements, the old (i.e., previously-rendered) advertisements may be deleted 108 from the above-described non-volatile storage device. For example, if advertisement process 10 obtains advertisements one at a time, each time that advertisement process 10 stores 104 (on the above-described non-volatile storage device) a second (i.e., replacement) advertisement, advertisement process 10 may delete 108 the first (i.e., original) advertisement from the above-described non-volatile storage device. Alternatively, if advertisement process 10 obtains the advertisements in lots, advertisement process 10 may sequentially render 102, 106 each advertisement included within the lot of advertisements prior to deleting 108 any of the advertisements. Accordingly, once the entire lot of advertisements has been rendered and a lot of new (i.e., replacement) advertisements has been obtained, advertisement process 10 may delete the previously-stored lot of advertisements from the above-described non-volatile storage device.

While the system is described above as obtaining advertisements from data server 30, which may execute server-side advertisement process 10′, other configurations are possible and are considered to be within the scope of this disclosure. For example, advertisement may be obtained from removable media (e.g., DVDs and CDs) that are inserted into personal computer 12 to e.g., install software applications. This installation of advertisements may be performed with or without the knowledge of e.g., user 46.

A number of implementations have been described. Nevertheless, it will be understood that various modifications may be made. Accordingly, other implementations are within the scope of the following claims.

What is claimed is:

1. A method comprising:
storing a first advertisement in a non-volatile storage device within a computing device;
rendering the first advertisement on the computing device during a first firmware boot sequence of the computing device; and
storing a second advertisement in the non-volatile storage device within the computing device.

2. The method of claim 1 further comprising:
rendering the second advertisement on the computing device during a second firmware boot sequence of the computing device.

3. The method of claim 1 further comprising:
deleting the first advertisement from the non-volatile storage device.

4. The method of claim 1 wherein the computing device is chosen from the group consisting of: a personal computer, a laptop computer, a notebook computer, a personal digital assistant, a cellular telephone, a portable game console and a personal media device.

5. The method of claim 1 wherein at least one of the first and second advertisements is chosen from the group consisting of: an audio-based advertisement; a text-based advertisement, a graphic-based advertisement and a video-based advertisement.

6. The method of claim 1 further comprising:
obtaining at least one of the first and second advertisements from a remote advertisement server coupled to the computing device via a distributed computing network.

7. The method of claim 1 wherein the non-volatile storage device is chosen from the group consisting of: a non-volatile storage device included within a video card; a non-volatile storage device included within a daughter card; a non-volatile storage device included within an audio card; a non-volatile storage device included within a network interface card; a non-volatile storage device included within a hard drive controller card; a non-volatile storage device included within a peripheral device controller card; and a non-volatile storage device included within a system board of the computing device.

8. The method of claim 1 wherein the non-volatile storage device is chosen from the group consisting of: a Programmable Read-Only Memory (PROM); an Erasable Programmable Read-Only Memory (EPROM); an Electrically Erasable Programmable Read-Only Memory (EEPROM); and a flash memory device.

9. The method of claim 1 wherein the firmware boot sequence includes a BIOS boot sequence.

10. A computer program product residing on a computer readable medium having a plurality of instructions stored thereon that, when executed by a processor, cause the processor to perform operations comprising:
storing a first advertisement in a non-volatile storage device within a computing device;
rendering the first advertisement on the computing device during a first firmware boot sequence of the computing device; and
storing a second advertisement in the non-volatile storage device within the computing device.

11. The computer program product of claim 10 further comprising instructions for:
rendering the second advertisement on the computing device during a second firmware boot sequence of the computing device.

12. The computer program product of claim 10 further comprising instructions for:
deleting the first advertisement from the non-volatile storage device.

13. The computer program product of claim 10 wherein the computing device is chosen from the group consisting of: a personal computer, a laptop computer, a notebook computer, a personal digital assistant, a cellular telephone, a portable game console and a personal media device.

14. The computer program product of claim 10 wherein at least one of the first and second advertisements is chosen from the group consisting of: an audio-based advertisement; a text-based advertisement, a graphic-based advertisement and a video-based advertisement.

15. The computer program product of claim 10 further comprising instructions for:
obtaining at least one of the first and second advertisements from a remote advertisement server coupled to the computing device via a distributed computing network.

16. The computer program product of claim 10 wherein the non-volatile storage device is chosen from the group consisting of: a non-volatile storage device included within a video card; a non-volatile storage device included within a daughter card; a non-volatile storage device included within an audio card; a non-volatile storage device included within a network interface card; a non-volatile storage device included within a hard drive controller card; a non-volatile storage device included within a peripheral device controller card; and a non-volatile storage device included within a system board of the computing device.

17. The computer program product of claim 10 wherein the non-volatile storage device is chosen from the group consisting of: a Programmable Read-Only Memory (PROM); an Erasable Programmable Read-Only Memory (EPROM); an Electrically Erasable Programmable Read-Only Memory (EEPROM); and a flash memory device.

18. The computer program product of claim 10 wherein the firmware boot sequence includes a BIOS boot sequence.

19. A computing device having circuitry configured for performing operations comprising:
storing a first advertisement in a non-volatile storage device within the computing device;
rendering the first advertisement on the computing device during a first firmware boot sequence of the computing device; and
storing a second advertisement in the non-volatile storage device within the computing device.

20. The computing device of claim 19 wherein the circuitry is further configured to perform operations comprising:
rendering the second advertisement on the computing device during a second firmware boot sequence of the computing device.

21. The computing device of claim 19 wherein the circuitry is further configured to perform operations comprising:
deleting the first advertisement from the non-volatile storage device.

22. The computing device of claim 19 wherein the computing device is chosen from the group consisting of: a personal computer, a laptop computer, a notebook computer, a personal digital assistant, a cellular telephone, a portable game console and a personal media device.

23. The computing device of claim 19 wherein at least one of the first and second advertisements is chosen from the group consisting of: an audio-based advertisement; a text-based advertisement, a graphic-based advertisement and a video-based advertisement.

24. The computing device of claim 19 wherein the circuitry is further configured to perform operations comprising:
obtaining at least one of the first and second advertisements from a remote advertisement server coupled to the computing device via a distributed computing network.

25. The computing device of claim 19 wherein the non-volatile storage device is chosen from the group consisting of: a non-volatile storage device included within a video card; a non-volatile storage device included within a daughter card; a non-volatile storage device included within an audio card; a non-volatile storage device included within a network interface card; a non-volatile storage device included within a hard drive controller card; a non-volatile storage device included within a peripheral device controller card; and a non-volatile storage device included within a system board of the computing device.

26. The computing device of claim 19 wherein the non-volatile storage device is chosen from the group consisting of: a Programmable Read-Only Memory (PROM); an Erasable Programmable Read-Only Memory (EPROM); an Electrically Erasable Programmable Read-Only Memory (EEPROM); and a flash memory device.

27. The computing device of claim 19 wherein the firmware boot sequence includes a BIOS boot sequence.
